(19) United States
(12) Patent Application Publication
(10) Pub. No.: US 2003/0144919 A1
(43) Pub. Date: Jul. 31, 2003

(54) Product sale process management system

(76) Inventors: Christophe Trompette, Heouville Saint-Clair (FR); Pascal Bar, Mouen (FR); Frederic Plessis, Caen (FR)

Correspondence Address: YOUNG & THOMPSON, 745 SOUTH 23RD STREET 2ND FLOOR, ARLINGTON, VA, 22202

(21) Appl. No.: 10/203,563

(22) PCT Filed: Feb. 13, 2001
(86) PCT No.: PCT/FR01/00414

(30) Foreign Application Priority Data
Feb. 14, 2000 (FR) 0001802

(51) Int. Cl. G06F 17/60

(52) U.S. Cl. 705/26; 705/39

(57) ABSTRACT

The invention concerns a system comprising data storage means (2), access means (20, 26) to the storage means and a management server (4) communicating with the storage means and comprising a pricing engine (10). The storage means (2) are accessible by an initial seller for producing and storing an initial offer for sale associated with conditions of the product sale, and by at least a retailer for producing and storing a contract for the intermediate purchase of said product and an intermediate offer for the sale of said product, derived from the contract, associated with sale conditions, the contract validating the conditions of the offer for sale of the previous seller, and furthermore by a final purchaser for producing and storing a contract for the final purchase of said product validating the conditions of the offer for sale of the last retailer.

The present invention relates to a system for managing a sales chain for a product, comprising data storage means, means of access to the storage means and a management server, in communication with the storage means and comprising a valuation engine.

For example, a known system makes it possible to manage the sale of a product by a purchaser as a function of a contract entered into between the latter and a seller, the terms of the contract, in particular the pricing conditions, being stored in memory in the storage means.

When the sales chain comprises several sellers, that is to say an initial seller and at least one reseller, the system does not make it possible to manage the entire chain automatically. Only the last link is managed, as a function of the contract entered into between the purchaser and the last reseller. Since the management of the remainder of the chain is not automated, the other users of the system have to calculate their incomes themselves as a function of the sales effected.

This results in non-automatic and hence difficult management of the sales chains comprising at least one reseller.

The invention aims to remedy the drawbacks of a conventional system by creating an automated system for managing a sales chain regardless of the number of intermediate resellers and regardless of their respective pricing conditions.

The subject of the invention is therefore a system for managing a sales chain for a product, comprising data storage means, means of access to the storage means and a management server, in communication with the storage means and comprising a valuation engine, characterized in that the storage means are accessible on the one hand by an initial seller for the formulation and the storage in these means of an initial offer for sale associated with conditions of sale of the product, on the other hand by at least one reseller for the formulation and the storage in the storage means of an intermediate purchase contract for this product and of an intermediate offer for sale for this product, derived from the contract and associated with conditions of sale, the contract validating the conditions of sale of the offer for sale of the previous seller, and furthermore by a final purchaser for the formulation and the storage in the storage means of a final purchase contract for this product validating the conditions of sale of the offer for sale of the last reseller.

This system thereby makes it possible to store in memory the contracts and the conditions of sale, in particular the pricing conditions, binding all the users of the system pairwise. Thus, with each consumption of the product, the system is capable of reconstructing the complete sales chain and of managing it automatically.

The system for managing a sales chain according to the invention can moreover comprise one or more of the following characteristics:

the storage means are accessible by several successive resellers for the successive formulation and successive storage of intermediate purchase contracts for this product and of intermediate offers for sale derived respectively from these contracts and associated with conditions of sale, each contract validating the conditions of sale of the offer for sale previously formulated and stored;

the storage means comprise accounts associated with each of the users of the system, be they initial seller, reseller or final purchaser, these accounts being accessible by the users through the means of access;

the valuation engine is adapted to manage the account of each user of the system as a function of the successive sales effected between them pairwise and of the respective purchase contracts; and

each offer for sale comprises a specific pricing offer and the valuation engine comprises a process of iterative calculation on each contract of the sales chain as a function of the specific pricing offer.

The invention will be better understood with the aid of the description which follows, given solely by way of example and whilst referring to the appended drawings in which:

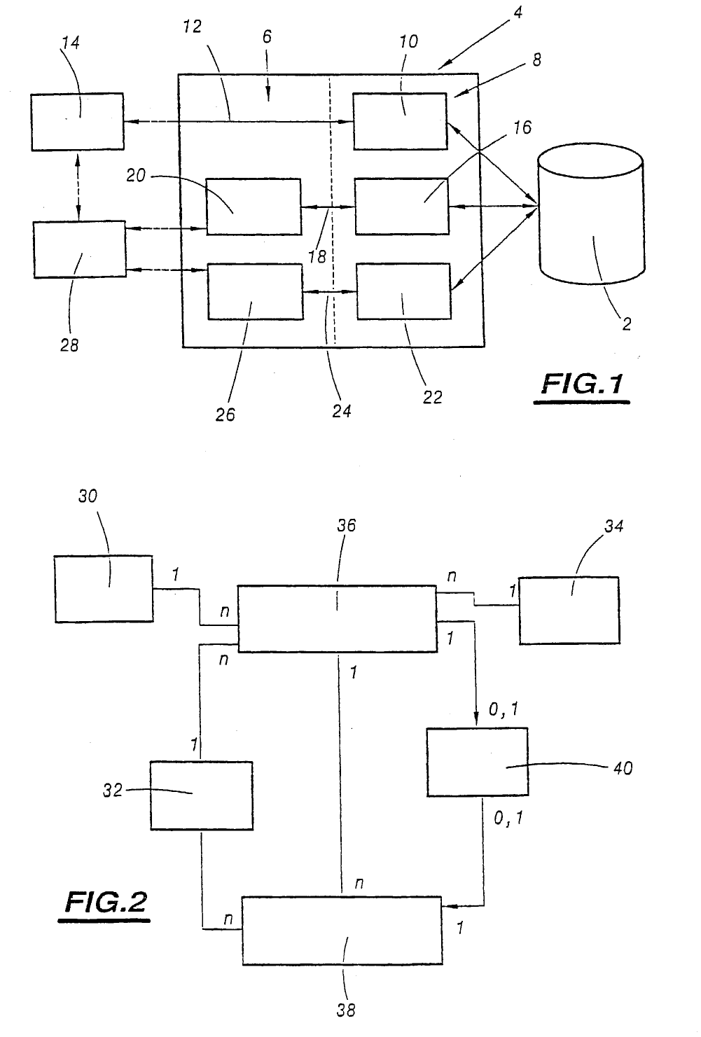

FIG. 1 is a layout illustrating the general structure of a system for managing a sales chain for a product according to the invention;

FIG. 2 represents a static diagram linking various elements stored in the storage means;

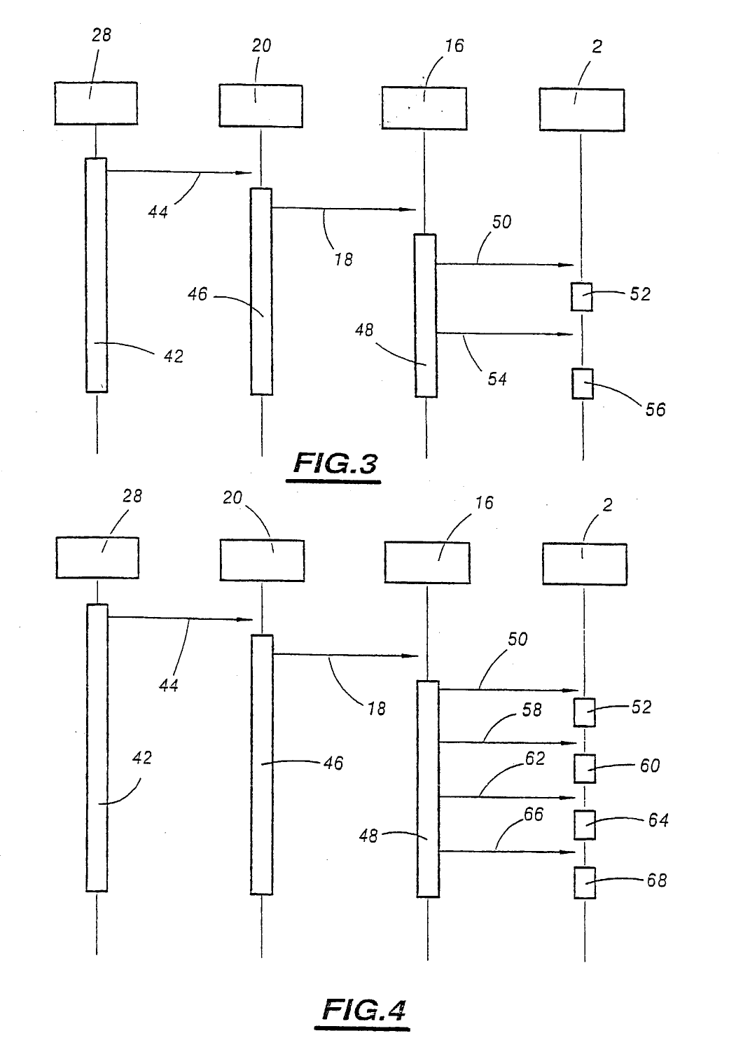

FIG. 3 represents a dynamic diagram detailing the process for formulating a contract by a user of the system; and

FIG. 4 represents a dynamic diagram detailing the process for formulating an offer for sale by a user of the system.

The system for managing a sales chain for a product represented in FIG. 1 comprises a database 2 and a management server 4. The management server 4 comprises software broken down into several modules of the client 6 or server 8 type.

One of the modules constitutes a valuation engine 10, of server type, and receives as input a consumption ticket 12 in the form of a signal formulated and transmitted by a remote application server 14 connected by an Internet type network to the management server 4. The consumption ticket comprises the reference of a purchase contract and consumption information relating to a product designated in the offer for sale validated by the contract.

On the basis of this information, the valuation engine interacts with the database 2 to calculate the debits and credits to be assigned with regard to accounts stored in the database and associated, each, with a user of the sales chain for the product consumed. The sequence of instructions executed by the engine 10 during this interaction will be detailed subsequently.

Another module constitutes a contracts server 16 which receives as input an order 18 to create an offer for sale or contract formulated and transmitted in the form of a signal originating from a third module consisting of description means 20, of client type. The order to create an offer for sale comprises the reference of a seller, the reference of a product, a pricing offer, general terms and/or the reference of a contract.

The order to create a contract comprises the reference of an offer for sale and the reference of a client.

On the basis of this information, the contracts server interacts with the database to create in the latter the contract or the offer for sale as a function of the create order. The sequence of instructions executed by the contracts server 16 during this interaction will be detailed subsequently with reference to FIGS. 3 and 4.

A fourth module constitutes an accounts server 22. It receives as input a display order 24 transmitted in the form of a signal originating from a fifth module consisting of monitoring means 26, of client type.

The display order comprises the reference of a user.

On the basis of this information, the accounts server 22 interacts with the database 2 so as to return the balance of the user's account, updated by the valuation engine 10, to the monitoring means.

The instructions executed by the accounts server 22 during this interaction are constituted by computer codes of conventional type which are appropriate for the use envisaged. They will therefore not be described subsequently.

The description means 20 are connected to a remote user server 28 by an Internet type network and are adapted for recording the information required for the formulation of an order 18 to create a contract or offer for sale.

Likewise, the monitoring means 26 are connected to the user server 28 by an Internet type network and are adapted for the recording of the information required for the formulation of a display order 24.

With reference to FIG. 2, the database comprises various classes of objects and bonds linking objects of different classes. Two objects of the same class are independent.

It may be seen in this figure that the database contains a Products class 30 which contains a list of objects, each defining a product presented for sale.

A Users class 32 contains a list of objects, each defining a user of the system through a reference to an account, not represented in this figure, stored in the database and through a type chosen from “seller”, “reseller” and “purchaser”.

A Pricing Offers class 34 contains a list of objects, each defining, as is conventional, a pricing offer.

An Offers for sale class 36 contains a list of objects, each defining an offer for sale and comprising general terms.

A Contracts class 38 contains a list of objects, each defining a contract.

Finally, a Delegation of contracts class 40 contains a list of objects, each defining a delegated contract.

Each offer for sale of the class 36 is furthermore defined by a bond to a product of the class 30, a bond to a user of the “seller” or “reseller” type of the class 32, a bond to a pricing offer of the class 34 and at most one bond to a delegated contract of the Delegation of contracts class 40.

The bond to a delegated contract exists only when the user is of the “reseller” type. In order for it to be validated, an offer for sale must furthermore be defined by at least one bond to at least one contract of the Contracts class 38.

Each contract of the Contracts class 38 is furthermore defined by a bond to a user of the “purchaser” or “reseller” type, a bond to an offer for sale and at most one bond with a delegated contract of the Delegation of contracts class 40. The latter bond exists only when the user is of the “reseller” type.

Each delegated contract of the Delegation of contracts class 40 is furthermore defined by a bond to an offer for sale of the class 36 and a contract of the Contracts class 38 which are bound to one and the same user of the “reseller” type.

Finally, each product is furthermore defined by at least one bond to an offer for sale, each pricing offer by at least one bond to an offer for sale, each user of the “purchaser” or “reseller” type by at least one bond to a contract and each user of the “seller” or “reseller” type by at least one bond to an offer for sale.

As will be described in detail subsequently, the database 2 is accessible, on the one hand, by an initial seller for the formulation and the storage in this database of an initial offer for sale associated with conditions of sale of the product, on the other hand, by one or more reseller(s) for the formulation and the storage in the database 2 of an intermediate purchase contract for this product and of an intermediate offer for sale for this product which is derived from the contract and which is associated with conditions of sale, the contract validating the conditions of sale of the offer for sale of the seller or of the previous reseller. The conditions of sale comprise general terms and a pricing offer.

Finally, the database 2 is accessible by a final purchaser for the formulation and the storage in this database of a final purchase contract for this product validating the conditions of sale of the offer for sale of the last reseller.

A sales chain is thus created between an initial seller, one or more intermediate reseller(s) and a final purchaser.

This chain is automatically activated by the valuation engine 10 of the management server 4 as soon as the final purchaser consumes or buys the product.

Thereupon, the management server 4, and in particular the valuation engine, carries out the management of the account of each user of the system, namely the initial seller, the reseller(s) and, optionally, the final purchaser, as a function of the successive sales effected pairwise between them and of the respective purchase contracts.

Thus, a user of the “purchaser” or “reseller” type creates a contract according to the process described in FIG. 3.

By means of the User server 28, he executes an activation 42 of the description means 20 by transmitting a signal 44 which comprises his identity as well as the reference of an offer for sale of the database which he wishes to validate.

Next, the description means drive transmission means 46 which transmit a create contract order 18 to the contracts server 16. The latter then controls means of management 48 of the database 2. These means execute on the one hand the transmission of an order 50 for the creation 52 of an additional object of the users class, of the “purchaser” or “reseller” type and of an associated account, if this object does not yet exist in the database and on the other hand the transmission of an order 54 for the creation 56 of an additional object of the Contracts class.

Moreover, a user of the “seller” or “reseller” type creates an offer for sale according to the process described in FIG. 4. Just as previously, by means of the user server, he drives the activation of the description means by transmitting the signal 44 which this time comprises his identity, the reference of a product, a pricing offer and general terms. When the user is of the “reseller” type, the signal also comprises the reference of a contract previously validated by himself.

Next, the description means drive the transmission means 46 which transmit an order 18 to create an offer for sale to the contracts server 16. The latter then controls the means of management 48 of the database 2. These means cause:

the transmission of an order 50 for the creation 52 of an additional object of the Users class, of the “seller” or “reseller” type and of an associated account, if this object does not yet exist in the database;

the transmission of an order 58 for the creation 60 of an additional object of the Products class, if this object does not yet exist in the database;

the transmission of an order 62 for the creation 64 of an additional object of the Pricing Offers class; and

the transmission of an order 66 for the creation 68 of an additional object of the Offers for sale class. This creation 68 comprises a step of recording the general terms in the database.

When the user is of the “reseller” type, the creation 68 furthermore comprises, on the one hand, a second step of creating a new delegated contract of the Delegation of contracts class, which contract is bound to the contract previously validated by the reseller and referenced in the signal 44, on the other hand, a third step of creating a bond between the offer for sale and this delegated contract.

Finally, a final user of the “purchaser” type activates a sales chain for a product according to the following process.

By means of the application server, he transmits a consumption ticket 12 and the reference of a contract to the valuation engine 10.

Then, the valuation engine consults the contract in the database 2, which contract returns the consumption ticket to the offer for sale which it validates in the database 2.

On the basis of the consumption ticket and of the pricing offer bound to the offer for sale validated by the contract indicated in the ticket, the valuation engine calculates an amount to be debited from the account of the purchaser and to be credited to the account of the seller bound to the offer for sale.

During this step, if the offer for sale is bound to a delegated contract of the class 40, the process is repeated, that is to say, the consumption ticket is transmitted to the contract bound to the delegated contract. The pricing offer of this latter contract is thus retrieved. The process is repeated until it reaches the last offer for sale which is not bound to any delegated contract.

It will be noted that the invention is not limited to the embodiment described.

Specifically, according to another embodiment, the Users class 32 does not contain any type chosen from “purchaser”, “seller” or “reseller”. In this case, a user behaves implicitly as a purchaser when he creates a contract, and as a seller when he creates an offer for sale and as a reseller when he creates an offer for sale mentioning a contract created by himself.

1. System for managing a sales chain for a product (30), comprising data storage means (2), means of access (20, 26) to the storage means and a management server (4), in communication with the storage means and comprising a valuation engine (10), characterized in that the storage means (2) are accessible on the one hand by an initial seller for the formulation and the storage in these means of an initial offer for sale (36) associated with conditions of sale of the product, on the other hand by at least one reseller for the formulation and the storage in the storage means (2) of an intermediate purchase contract (38) for this product and of an intermediate offer for sale (36) for this product, derived from the contract and associated with conditions of sale, the contract validating the conditions of sale of the offer for sale of the previous seller, and furthermore by a final purchaser for the formulation and the storage in the storage means of a final purchase contract for this product validating the conditions of sale of the offer for sale of the last reseller.

2. System for managing a sales chain for a product according to claim 1, characterized in that the storage means (2) are accessible by several successive resellers for the successive formulation and successive storage of intermediate purchase contracts (38) for this product and of intermediate offers for sale (36) derived respectively from these contracts and associated with conditions of sale, each contract validating the conditions of sale of the offer for sale previously formulated and stored.

3. System for managing a sales chain for a product according to claim 1 or 2, characterized in that the storage means (2) comprise accounts associated with each of the users (32) of the system, be they initial seller, reseller or final purchaser, these accounts being accessible by the users through the means of access (20, 26).

4. System for managing a sales chain for a product according to claim 3, characterized in that the valuation engine (10) is adapted to manage the account of each user (32) of the system as a function of the successive sales effected between them pairwise and of the respective purchase contracts (38).

5. System for managing a sales chain for a product according to one of claims 1 to 4, characterized in that each offer for sale (36) comprises a specific pricing offer (34) and in that the valuation engine (10) comprises a process of iterative calculation on each contract of the sales chain as a function of the specific pricing offer.
